(19) United States
(12) Patent Application Publication
(10) Pub. No.: US 2008/0016700 A1
(43) Pub. Date: Jan. 24, 2008

(54) High leverage bolt cutter

(76) Inventors: Hector R. Hernandez, Fullerton, CA (US); George Hillinger, Los Angeles, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/489,153

(22) Filed: Jul. 18, 2006

(51) Int. Cl. B26B 17/00

(52) U.S. Cl. 30/190

(57) ABSTRACT

A cutting tool includes a first and second pivoted levers for opening and closing and a pair workpiece engagement members having one or more cutting edges. One of the workpiece engagement members is pivotably attached to the fist and second members, while the other workpiece engagement member is fixedly attached to the second lever. The levers connected together by a linkage having one end fixed in position the first lever and having another end slideably attached to the second lever by of a slide element. An adjustment device is connected to the side element and to a rotatable handle on the first handle. The adjustment device moves and holds the slide element in a plurality of positions which correspond to different cutting ratios. An associated method of use is also disclosed in which the rotatable handle is used to adjust the cutting ratio while the tool is engaged with a workpiece.

### FIELD OF THE INVENTION

The invention relates generally to cutting tools and, more particularly, to an adjustable cutting tool with hinged handles and a pivoting blade.

### BACKGROUND OF THE INVENTION

Conventional cutting tools are generally made up of two handles connected to a pair of opposing jaws or workpiece engagement members which can be manually separated or brought together by movement of the handles. The connection of the handles to the jaws can be designed to create increased leverage and, thus, greater cutting force. A prior design makes use of a four-bar mechanism, where the two handles make up two of the bars, one of the jaws makes up a third bar, and linkage makes up a fourth bar. A screw-type adjustment device may be used to move the arm or linkage along one of the handles for the purpose of altering the effective length of the third bar. By altering the length of the third bar, the leverage of the tool may be adjusted. A disadvantage of prior designs is that a user must remove his hand from the handle in order to rotate the screw-type adjustment device.

When cutting bolts and other hardened metal pieces, it is advantageous to use a cutting tool with a relatively high leverage. A draw back of high leverage cutting tools their low cutting ratio. That is, the handles of many high leverage cutting tools must be moved a great distance in order produce a slight movement in the jaws, which limits the ability of the tool to accept a large workpiece between its jaws. Double-action cutters have been designed to cut large workpieces; however, double-action cutters involve more parts than single-action cutters, which increases cost.

There is a need for a low-cost cutting tool capable with a high cutting force and a jaw opening capable of accepting a wide variant of workpiece sizes. There is also a need for a cutting tool having an adjustable cutting ratio that may be adjusted easily while the tool is engaged on the workpiece. The present invention satisfies these and other needs.

### SUMMARY OF THE INVENTION

Briefly and in general terms, the present invention is directed to an adjustable cutting tool and a method of cutting a workpiece using an adjustable cutting tool. In aspects of the present invention, a tool comprises a first lever including a rear portion, a front portion, a first grip rotatably attached to the rear portion of the first lever, a stationary workpiece engagement member disposed at the front portion of the first lever, a medial portion disposed between the rear and front portions of the first lever, and a retention device formed at the medial portion, a second lever moveable relative to the first lever, the second lever including a rear portion, a front portion, and a second grip attached to the rear portion of the second lever, a moveable workpiece engagement member including a first pivot and a second pivot spaced apart from the first pivot, the first pivot pivotably attached to the front portion of the first lever, the second pivot pivotably attached to the front portion of the second lever, a cutting edge formed on any one of the workpiece engagement members, a linkage connecting the first and second levers, the linkage including a third pivot pivotably attached to the front portion of the second lever, the third pivot being spaced apart from the second pivot of the moveable workpiece engagement member, the linkage further including a fourth pivot pivotably and slideably coupled to the medial portion of the first lever, thereby establishing an adjustable linear distance between the fourth pivot of the linkage and the first pivot of the moveable workpiece engagement member, and an adjustment device connected to the first grip, the adjustment device including a slide element pivotably connected to the fourth pivot of the linkage, the slide element retained in a sliding relationship with the medial portion by the retention device formed at the medial portion, the adjustment device configured to translate rotation of the first grip into sliding movement of the slide element along the medial portion, thereby permitting a change in the linear distance between the fourth pivot and the first pivot by rotation of the first grip.

In detailed aspects of the present invention, the first lever includes a first channel having a bottom wall and two opposing side walls extending from the bottom wall, the bottom and side walls defining an interior portion within which the slide element may be moved along the medial portion. The retention device formed at the medial portion includes a rib formed on any one of the two side walls of the first channel, the rib protruding into the interior portion of the first channel and extending substantially parallel to the bottom wall of the first channel, the slide element being retained between the rib and the bottom wall.

In other detailed aspects, the adjustment device further includes a stationary threaded member attached to the rear portion of the first lever and an elongate, moveable threaded member attached to the first grip and the slide element, the threaded members coupled together such that the slide element moves during rotation of the first grip. In further aspects, the moveable threaded member includes an annular notch, and the slide element includes a U-shaped member having a base, two opposing arms extending from the base, a fourth pivot pin connected to at least one of the two arms, and an open-ended slot formed at the base, the fourth pivot pin configured to engage the fourth pivot of the linkage, the open-ended slot configured to engage the annular notch of the moveable threaded member.

In yet other detailed aspects, the second lever further includes a second channel having a bottom portion, two opposing side portions extending from the base portion, a second pivot pin connecting the two side portions, and a third pivot pin connecting the two side portions and spaced apart from the second pivot pin, the second pivot pin configured to engage the second pivot of the moveable workpiece engagement member, the third pivot pin configured to engage the third pivot of the linkage. In further aspects, the linkage includes a tab portion, the tab portion having a stop surface disposed at a distance from a line defined by the third and fourth pivots of the linkage, the distance selected such that the stop surface abuts the bottom portion of the second channel to limit movement of the second lever toward the first lever, thereby preventing the second grip from contacting the first grip.

In more detailed aspects, the first lever further includes an elongate slot, the tool further comprising a limit device that limits movement of the slide element along the medial portion of the first lever, the limit device including a protrusion extending into the elongate slot and attached to the moveable workpiece engagement member at a point spaced apart from the first and second pivots of the moveable workpiece engagement member, and wherein the elongate slot has a minor dimension sized to accommodate the protrusion and a major dimension sized to allow the moveable workpiece engagement member to rotate about the first pivot during movement of the slide element, the elongate slot located on the first lever relative to the first pivot such that movement of the slide element is stopped at selected point on the medial portion.

In yet other detailed aspects, the first grip is sized and configured to accommodate one hand of a user and the second grip is sized and configured to accommodate the other hand of the user.

In other aspects of the present invention, a tool comprises an elongate first lever including a first rear portion and a first front portion, a first workpiece engagement member connected on the first lever, an elongate second lever including a second rear portion moveable relative to the first rear portion, a second front portion, and a medial portion disposed between the second front portion and the second rear portion, a second workpiece engagement member including first and second pivots, the first and second pivots pivotably connected the first and second front portions, respectively, such that the second workpiece engagement member is adjacent the first workpiece engagement member, a cutting edge formed on any one of the workpiece engagement members, a slide element coupled to the medial portion of the second lever and retained in a sliding relationship with the medial portion, an adjustment device connected to the first lever and configured to hold the slide element at selected positions along the medial portion, and a linkage having third and fourth pivots, the third and fourth pivots pivotably connected to the second front portion and the coupling device, respectively, such that the second workpiece engagement member moves away from the first workpiece engagement member during movement of the second rear portion away from the first rear portion, thereby defining a cutting ratio between movement of the workpiece engagement members away from each other and movement of the rear portions away from each other, wherein the selected positions of the slide element include a first position and a second position, the first position associated with a first cutting ratio, the second position associated with a second cutting ratio greater than the first cutting ratio.

In detailed aspects, the first position of the slide element defines a first distance between the fourth pivot and the first pivot, and the second position of the slide element defines a second distance between the fourth pivot and the first pivot, the second distance being less than the first distance.

In still other aspects of the present invention, a method of cutting a workpiece with a tool having a first lever, a first handle disposed on the first lever, a second lever, a second handle disposed on the second lever, a first blade disposed on the first lever, a second blade having first and second pivots pivotably attached to the first and second levers, respectively, a linkage having third and fourth pivots pivotably attached to the first and second levers, respectively, and an adjustment device connected to the first handle and the fourth pivot, the adjustment device configured to hold the fourth pivot at selected distances from the first pivot, the distances selected by rotation of the first handle, the method comprises creating an opening between the first and second blades, including separating the first and second handles from each other, inserting a workpiece into the opening between the first and second blades, pushing the blades into the workpiece, including grasping the first and second handles and moving the first and handles toward each other a first time, separating the first and second handles while keeping the first and second blades on the workpiece, including rotating the first handle while grasping the first and second handles, and pushing the blades further into the workpiece after rotating the first handle, including moving the first and second handles toward each other a second time.

The features and advantages of the invention will be more readily understood from the following detailed description which should be read in conjunction with the accompanying drawings.

### BRIEF DESCRIPTION OF THE DRAWINGS

FIG. 1 is a perspective view of a tool in accordance with an embodiment of the present invention showing a first lever, a second lever, a linkage connecting the first and second levers, a first workpiece engagement member attached to the first lever, a second workpiece engagement member pivotably attached to the first and second levers, a first handle on the first lever, and a second handle on the second lever;

FIG. 2 is an exploded view of the tool of FIG. 1 showing pivot pins for connecting the first lever, second lever, linkage, first thread engagement member, second thread engagement member, and linkage, and showing a U-shaped slide element connecting one end of the linkage to an adjustment device having a stationary threaded member connected to the first lever and a moveable threaded member connected to first lever;

FIG. 3 is sectional view of the tool of FIG. 1 showing the tool in an open configuration with the adjustment device holding the slide element at a first position relative to a first pivot of the second engagement member, the slide member disposed within an interior portion of the first lever and retained by a rib formed on a medial portion of the first lever

FIG. 4 is sectional view of the tool of FIG. 1 showing the tool in an closed configuration with the adjustment device holding the slide element at a first position relative to the first pivot of the second engagement member, and showing a tab portion of the linkage abutting the bottom portion of a second channel of the second lever;

FIG. 5 is a sectional view of the tool of FIG. 1 showing the tool in an open configuration with the adjustment device holding the slide element at a second position relative to the first pivot of the second engagement member, the slide element being closer to the first pivot as compared to FIGS. 3 and 4;

FIG. 6 is a sectional view of the tool of FIG. 1 showing the tool in an closed configuration with the adjustment device holding the slide element at a second position relative to the first pivot of the second engagement member;

FIG. 7 is a detailed perspective view of the U-shaped slide element showing a base, opposing arms extending from the base, a pivot pin slot connecting the two arms and configured to engage the linkage, and a slot configured to engage the moveable threaded member of the adjustment device; and

FIG. 8 is a perspective view of a tool in accordance with another embodiment of the present invention showing cutting edges that are substantially parallel to the pivot axis of the second workpiece engagement member.

### DETAILED DESCRIPTION OF THE PREFERRED EMBODIMENTS

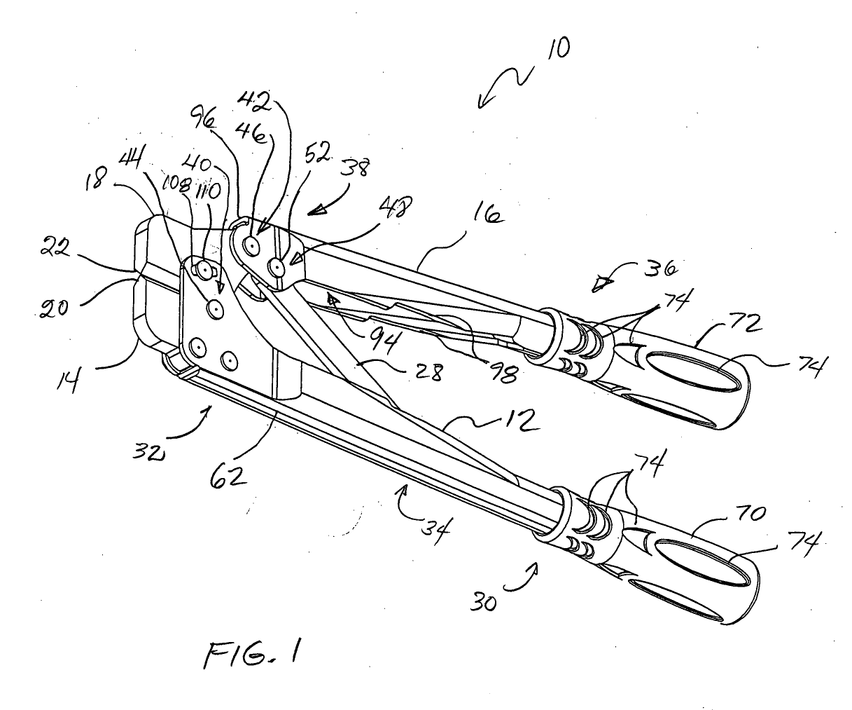

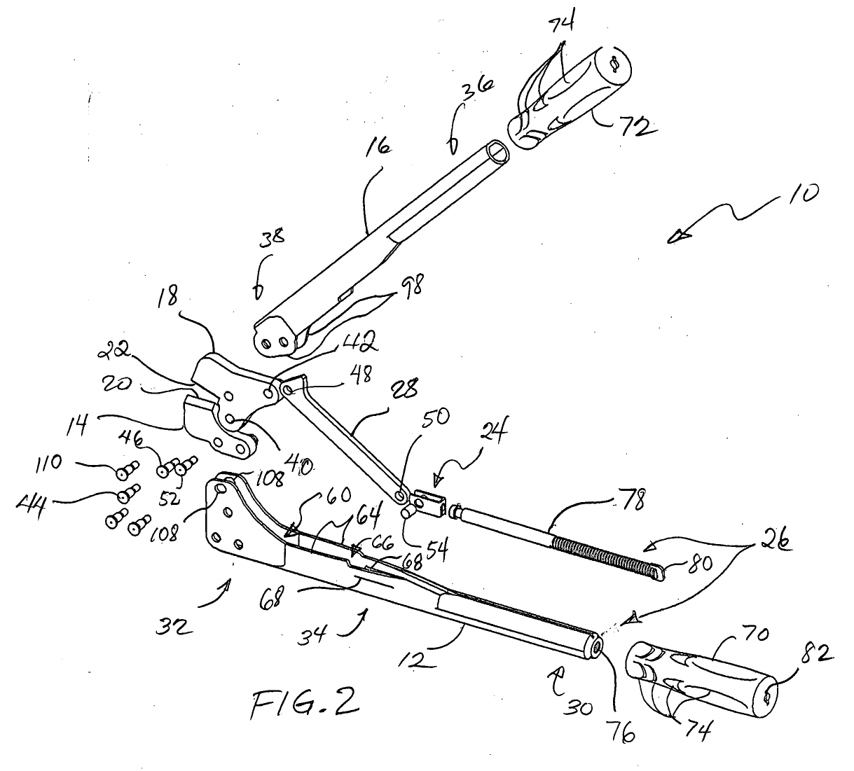

Referring now in more detail to the exemplary drawings for purposes of illustrating embodiments of the invention, wherein like reference numerals designate corresponding or like elements among the several views, there is shown in FIGS. 1 and 2 a tool 10 comprising an elongate first lever 12, a first workpiece engagement member 14 connected to the first lever, an elongate second lever 16, a second workpiece engagement member 18 pivotably connected to the second lever, cutting edges 20, 22 formed on the first and second workpiece engagement members, a slide element 24 (FIG. 2), an adjustment device 26 (FIG. 2), and a linkage 28. The first lever includes a first rear portion 30, a first front portion 32, and a medial portion 34 disposed between the first front portion and the first rear portion. The second lever includes a second rear portion 36 and a second front portion 38.

With continued reference to FIGS. 1 and 2, the second workpiece engagement member 18 is located adjacent the first workpiece engagement member 14. The second workpiece engagement member includes a first pivot 40 and a second pivot 42. In the illustrated embodiment, the first and second pivots are in the form of holes on the second workpiece engagement member. The first pivot is pivotably connected to the first front portion 32 by means of a first pivot pin 44 extending through a first set of holes in the second workpiece engagement member and the first front portion. The second pivot is pivotably connected to the second front portion 32 by means of a second pivot pin 46 extending through a second set of holes in the second workpiece engagement member and the second front portion 36.

Referring to FIG. 2, the slide element 24 is coupled to the medial portion 34 of the second lever 12 and is retained in a sliding relationship with the medial portion. The adjustment device 26 (FIG. 2) is connected to the first lever 12 and is configured to hold the slide element at selected positions along the medial portion. When the tool is fully assembled as shown in FIG. 1, the slide element and adjustment device are located within the first lever. Further details of the slide element and the adjustment device are provided below.

Referring to FIGS. 1 and 2, the linkage 28 includes a third pivot 48 and a fourth pivot 50. In the illustrated embodiment, the first and second pivots are in the form of holes on the linkage. The third pivot is pivotably connected to the second front portion 38 by means of a third pivot pin 52 extending through a third set of holes in linkage and the second front portion. The fourth pivot is pivotably connected to the slide element 24 by means of a fourth pivot pin 54 extending through a fourth set of holes in the linkage and the slide element. It will be appreciated that, the linkage is pivotably and slideably coupled to the medial portion 34 of the first lever 12.

In operation, the second rear portion is moveable relative to the first rear portion. As discussed further below, the second workpiece engagement member moves away from the first workpiece engagement member during movement of the second rear portion away from the first rear portion. These two sets of movement define a cutting ratio, which is the ratio between movement of the workpiece engagement members away from each other and movement of the rear portions away from each other. Movement of the workpiece engagement members associated with a high cutting ratio is greater than movement of the workpiece engagement members associated with a low cutting ratio given the same amount of movement of the rear portions. It is to be understood that greater leverage in cutting a workpiece is achieved under a relatively lower cutting ratio.

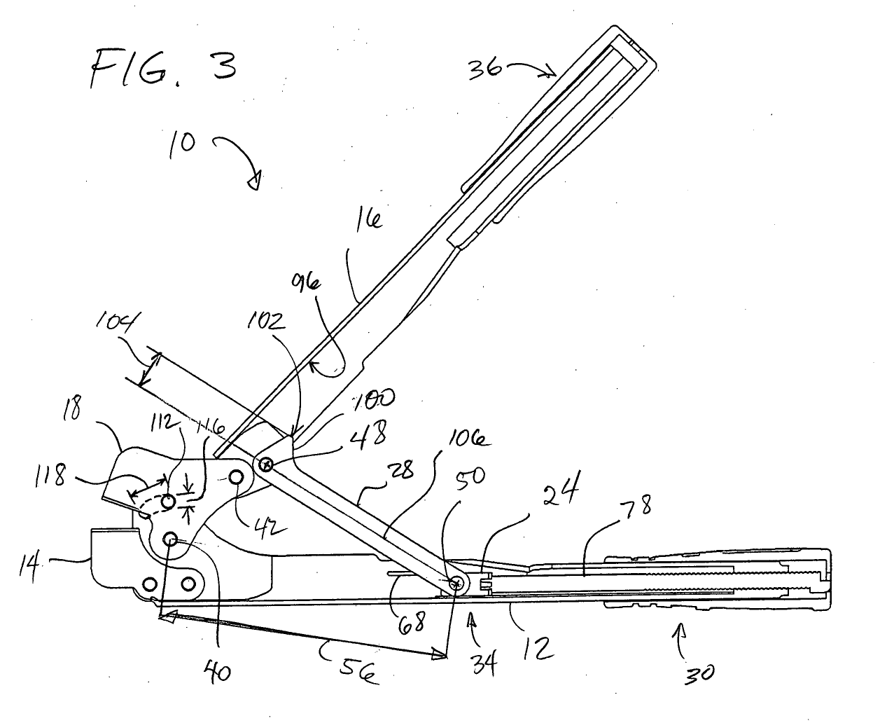

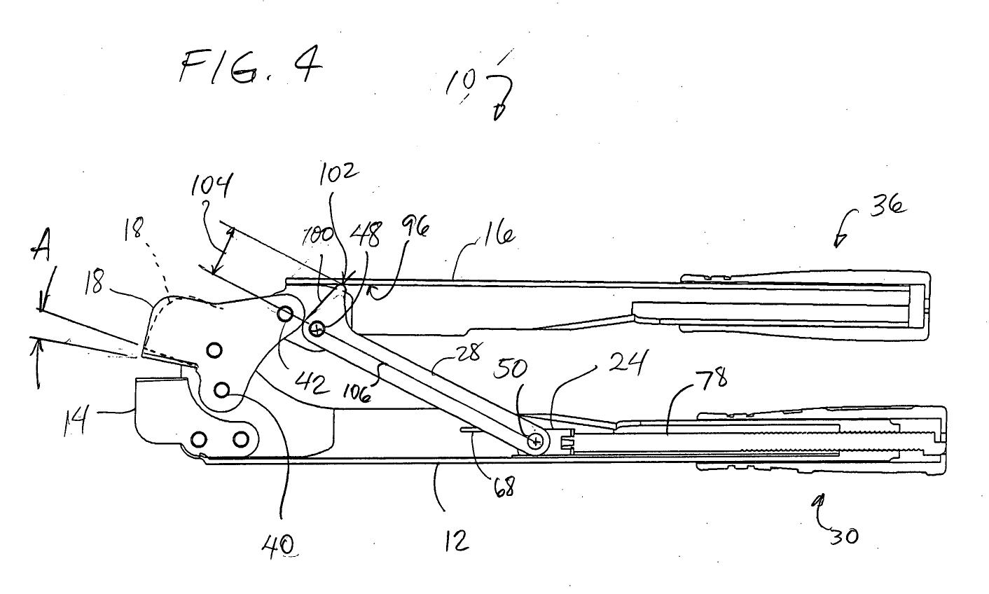

Referring now to FIGS. 3 and 4, the tool 10 is shown with a slide element 24 at a first position associated with a relatively low cutting ratio. In FIG. 3, the tool is shown in an open configuration, wherein the rear portions 30, 36 have been moved as far apart as possible to create a maximum opening between the workpiece engagement members 14, 18. In FIG. 4, the tool is shown in a closed configuration, wherein the rear portions have been moved as close together as possible in order to move the workpiece engagement members together. The dashed lines in FIG. 4 indicate the position of the second workpiece engagement member 18 in FIG. 3. As can be seen in comparing FIGS. 3 and 4, movement of the second lever toward the first lever results in rotation of the second workpiece engagement member 18 about the first pivot 40. For future reference, the amount of rotation the second workpiece engagement member is designated as angle A.

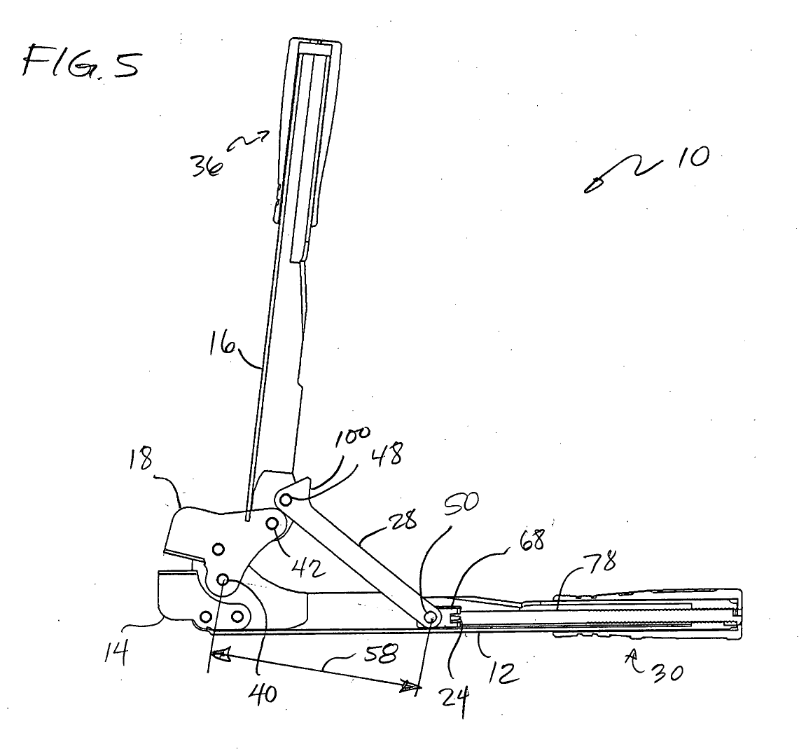

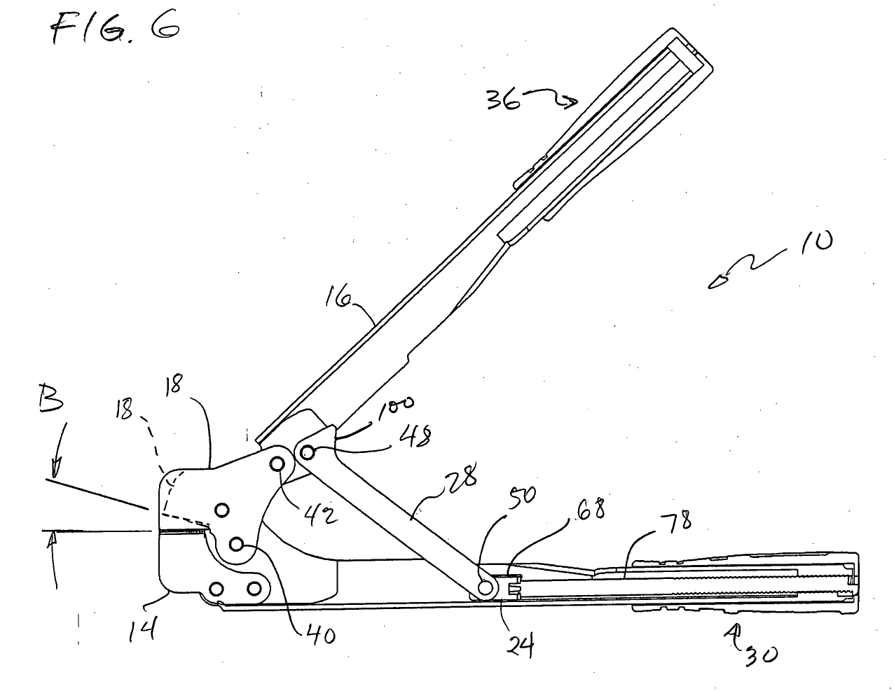

Referring now to FIGS. 5 and 6, the tool 10 of FIGS. 3 and 4 is shown with the slide element 24 at a second position associated with a relatively high cutting ratio. In FIG. 5, the tool is shown in an open configuration, wherein the rear portions 30, 36 have been moved as far apart as possible to create a maximum opening between the workpiece engagement members 14, 18. In FIG. 6, the tool is shown in a closed configuration, wherein the rear portions have been moved until the workpiece engagement members are in contact with each other. The dashed lines in FIG. 6 indicate the position of the second workpiece engagement member 18 in FIG. 5. The amount of rotation of the second workpiece engagement member is designated as angle B. As can be seen in comparing FIGS. 4 and 6, angle B is greater than angle A. It will be appreciated that greater cutting leverage is achieved with the slide element set the first position (FIGS. 3 and 4), which is associated with a low cutting ratio, as compared to the cutting leverage achieved with the slide element set at the second position (FIGS. 5 and 6).

Referring again to FIG. 3, the first position of the slide element 24 defines a first straight-line distance 56 between the fourth pivot 50 and first pivot 40. Referring again to FIG. 4, the second position of the slide element defines a second straight-line distance 58 between the fourth pivot and the first pivot. As can be seen in FIGS. 3 and 4 that second straight-line distance 58 defined by the second position is less than first straight-line distance 56 defined by the first position. It will be appreciated from this difference in distance that various cutting ratios can be achieved by adjusting the position of the slide device 24 along the medial portion 34 of the first lever 12.

Turning again to FIG. 2, the first lever 12 includes a first channel 60 having a bottom wall 62 (FIG. 1) and two opposing side walls 64 extending from the bottom wall. The bottom and side walls define an interior portion 66 within which the slide element 24 may be moved along the medial portion 34 of the first lever. The medial portion includes a retention device 68 in the form of a rib formed on both of the side walls. The rib protrudes into the interior portion and extends substantially parallel to the bottom wall. When the tool is assembled (FIG. 1), the slide element is retained between the rib and the bottom wall.

Still referring to FIG. 2, the first lever 12 further includes a first grip or handle 70 rotatably attached to the first rear portion 30. The second lever 26 includes a second grip or handle 72 attached to the second rear portion 36. Preferably, the handles 70, 72 are cylindrical and are each sized and configured to accommodate an entire hand of a user of the tool. In the illustrated embodiment, the handles include anti-slip features in the form of recesses on the surface of the handles.

The adjustment device 26 includes a stationary threaded member 76 and an elongate, moveable threaded member 78. The stationary threaded member has inward facing threads and is attached to the first rear portion 30. The moveable threaded member has outward facing threads and is attached to the first handle 70 by means of a key element 80 disposed at one end of the moveable threaded member. The key element mates with a key slot 82 formed in the first handle 70. The threaded members 76, 78 are coupled together by means of thread engagement such that the slide element 24 changes position during rotation of the first handle. It will be appreciated that the adjustment device is configured to translate rotation of the first handle into sliding movement of the slide element along the medial portion 34 of the first lever 12.

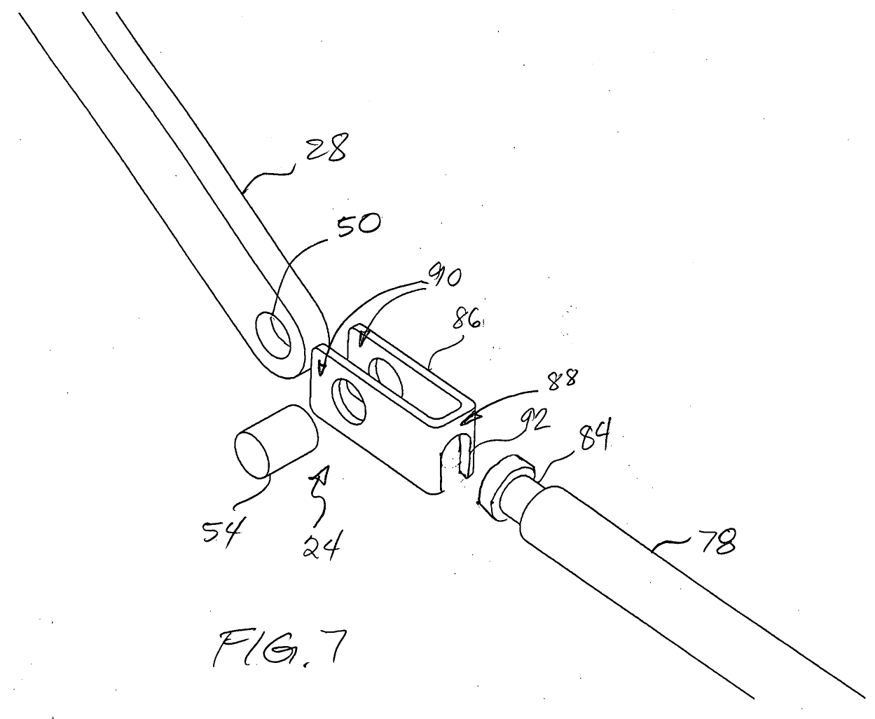

Turning now to FIG. 7, the moveable threaded member 78 of the adjustment device 26 includes an annular notch 84 configured to engage the slide element 24. The slide element includes a U-shaped member having a base 88, two opposing arms 90 extending from the base, and a fourth pivot pin 54 connected to the two arms, and an open-ended slot 92. The open-ended slot is configured to engage the annular notch of the moveable threaded member. It will be appreciated that other means of engagement between the slide element and the moveable threaded member may be used. For example, in an alternative embodiment not shown, the open-ended slot may be replaced by a circular hole through which the moveable threaded member may extend. In alternative embodiment, the moveable threaded member may be held in place by a screw, lock pin, or other by means known in the art.

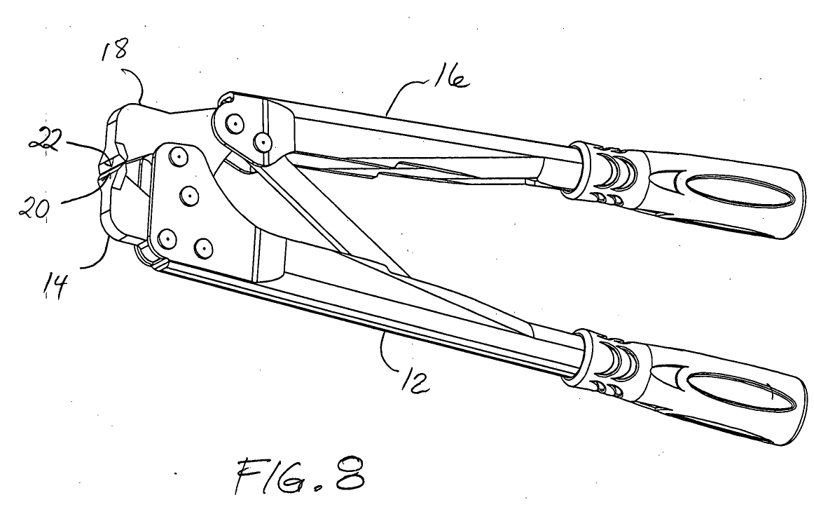

As shown in FIGS. 1-7, the cutting edges 20, 22 on the first and second workpiece engagement members 14, 18 are substantially parallel to the elongate first and second levers 12, 16. In another embodiment shown in FIG. 8, the cutting edges 20, 22 are positioned at an angle to the first and second levers. In the illustrated embodiment, the cutting edges extend in a direction substantially parallel to the pivot axis of the second workpiece engagement member. The cutting edges are at a ninety degree angle to the first and second levers. It will be appreciated that other angles may be used. While two cutting edges are shown in FIGS. 1-8, other embodiments not shown include a single cutting edge on either the first workpiece engagement member 14 or the second workpiece engagement member 18.

Referring again to FIGS. 1 and 2, the second lever 16 further includes a second channel 94 having a bottom portion 96 (FIG. 1), two opposing side portions 98 extending from the bottom portion. In another embodiment, the second lever further includes the second pivot pin 46 and the third pivot pin 52. The second pivot pin 46 connects the two side portions and is configured to engage the second pivot 42 of the second workpiece engagement member 18. The third pivot pin 52 also connects the two side portions, is spaced apart from the second pivot pin, and is configured to engage the third pivot 48 of the linkage 28.

Referring again to FIGS. 3 and 4, the linkage 28 includes a tab portion 100. The tab portion has a stop surface 102 disposed at a distance 104 from a line 106 defined by the third and fourth pivots 48, 50 of the linkage. As shown in FIG. 4, the distance 104 is selected such that the stop surface abuts the bottom portion 96 of the second channel 94. In this way, the stop surface prevents the second rear portion 36 from contacting the first rear portion 30.

Referring again to FIGS. 1 and 2, an elongate slot 108 is formed on the side walls 64 of the first lever 12. The tool 10 further comprises a limit device that includes a protrusion extending into the elongate slot and is attached to the second workpiece engagement member 18 at a point spaced apart from the first and second pivots 40, 42. In the illustrated embodiment, the protrusion is in the form of a fifth pivot pin 110. The fifth pivot pin extends through and is fixedly attached to a hole 112 (FIG. 3) on the second workpiece engagement member.

In FIG. 3 there is shown dashed lines 114 surrounding the hole 112 on the second workpiece engagement member 18. The dashed lines represent the outline of the elongate slot 108. The elongate slot has a minor dimension 116 sized to accommodate the fifth pivot pin 110 and a major dimension 118 sized to allow the second workpiece engagement member to rotate about the first pivot 40 during movement of the slide element 24. The elongate slot is located on the first lever 12 relative to the first pivot such that movement of the slide element is stopped at a selected point on medial portion 34 of the first lever 12. In the illustrated embodiment, the fifth pivot pin is abutting one end of the elongate slot, thereby preventing movement of the slide element further toward the first rear portion 32. As such, the selected point in the illustrated embodiment corresponds to the first position of the slide element.

In use, the tool 10 may be adjusted to cut workpieces of varying sizes. Where the workpiece is relatively large, the slide element 24 may be initially positioned to achieve a low cutting ratio to achieve greater cutting leverage. In this way, larger or hardened workpieces, such as bolts and other metal parts, may be easily cut. It will be appreciated that a high leverage bolt cutter may be configured in accordance with the invention.

An advantageous method of cutting a workpiece using a tool in accordance with an embodiment of the present invention will now be described. The user may create an opening between the first and second workpiece engagement members or blades 14, 18 by separating the first and second handles 72, 70 from each other. The user may then position the tool 10 so as to insert a workpiece into the opening between the blades. Next, the user pushes the blades into the workpiece by grasping the first and second handles and moving them toward each other. In this way, the cutting of the workpiece is initiated more easily with a low cutting ratio. After the workpiece has been partially cut, the user may separate the first and second handles while keeping the blades on the workpiece. Separation of the handles is conveniently achieved by rotating the handle connected to the adjustment device while grasping the other handle to keep the tool positioned on the workpiece. Thereafter, the user may cut the workpiece further by moving the handles toward each other a second time, which moves the blades further into the workpiece. It will be appreciated that this method has the advantage of allowing the user to continue to cut the workpiece while not removing his hands from the handles.

While several particular forms of the invention have been illustrated and described, it will also be apparent that various modifications can be made without departing from the scope of the invention. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

We claim:

1. An adjustable tool for cutting a workpiece, the tool comprising:
a first lever including a rear portion, a front portion, a first grip rotatably attached to the rear portion of the first lever, a stationary workpiece engagement member disposed at the front portion of the first lever, a medial portion disposed between the rear and front portions of the first lever, and a retention device formed at the medial portion;
a second lever moveable relative to the first lever, the second lever including a rear portion, a front portion, and a second grip attached to the rear portion of the second lever;
a moveable workpiece engagement member including a first pivot and a second pivot spaced apart from the first pivot, the first pivot pivotably attached to the front portion of the first lever, the second pivot pivotably attached to the front portion of the second lever;
a cutting edge formed on any one of the workpiece engagement members;
a linkage connecting the first and second levers, the linkage including a third pivot pivotably attached to the front portion of the second lever, the third pivot being spaced apart from the second pivot of the moveable workpiece engagement member, the linkage further including a fourth pivot pivotably and slideably coupled to the medial portion of the first lever, thereby establishing an adjustable linear distance between the fourth pivot of the linkage and the first pivot of the moveable workpiece engagement member; and
an adjustment device connected to the first grip, the adjustment device including a slide element pivotably connected to the fourth pivot of the linkage, the slide element retained in a sliding relationship with the medial portion by the retention device formed at the medial portion, the adjustment device configured to translate rotation of the first grip into sliding movement of the slide element along the medial portion, thereby permitting a change in the linear distance between the fourth pivot and the first pivot by rotation of the first grip.

2. The tool of claim 1 wherein the first lever includes a first channel having a bottom wall and two opposing side walls extending from the bottom wall, the bottom and side walls defining an interior portion within which the slide element may be moved along the medial portion.

3. The tool of claim 2 wherein the retention device formed at the medial portion includes a rib formed on any one of the two side walls of the first channel, the rib protruding into the interior portion of the first channel and extending substantially parallel to the bottom wall of the first channel, the slide element being retained between the rib and the bottom wall.

4. The tool of claim 1 wherein the adjustment device further includes a stationary threaded member attached to the rear portion of the first lever and an elongate, moveable threaded member attached to the first grip and the slide element, the threaded members coupled together such that the slide element moves during rotation of the first grip.

5. The tool of claim 4 wherein:
the moveable threaded member includes an annular notch; and
the slide element includes a U-shaped member having a base, two opposing arms extending from the base, a fourth pivot pin connected to at least one of the two arms, and an open-ended slot formed at the base, the fourth pivot pin configured to engage the fourth pivot of the linkage, the open-ended slot configured to engage the annular notch of the moveable threaded member.

6. The tool of claim 1 wherein the second lever further includes a second channel having a bottom portion, two opposing side portions extending from the base portion, a second pivot pin connecting the two side portions, and a third pivot pin connecting the two side portions and spaced apart from the second pivot pin, the second pivot pin configured to engage the second pivot of the moveable workpiece engagement member, the third pivot pin configured to engage the third pivot of the linkage.

7. The tool of claim 6 wherein the linkage includes a tab portion, the tab portion having a stop surface disposed at a distance from a line defined by the third and fourth pivots of the linkage, the distance selected such that the stop surface abuts the bottom portion of the second channel to limit movement of the second lever toward the first lever, thereby preventing the second grip from contacting the first grip.

8. The tool of claim 1 wherein the first lever further includes an elongate slot;
the tool further comprising a limit device that limits movement of the slide element along the medial portion of the first lever, the limit device including a protrusion extending into the elongate slot and attached to the moveable workpiece engagement member at a point spaced apart from the first and second pivots of the moveable workpiece engagement member; and
wherein the elongate slot has a minor dimension sized to accommodate the protrusion and a major dimension sized to allow the moveable workpiece engagement member to rotate about the first pivot during movement of the slide element, the elongate slot located on the first lever relative to the first pivot such that movement of the slide element is stopped at selected point on the medial portion.

9. The tool of claim 1 wherein the first grip is sized and configured to accommodate one hand of a user and the second grip is sized and configured to accommodate the other hand of the user.

10. An adjustable tool for cutting a workpiece, the tool comprising:
an elongate first lever including a first rear portion and a first front portion;
a first workpiece engagement member connected on the first lever;
an elongate second lever including a second rear portion moveable relative to the first rear portion, a second front portion, and a medial portion disposed between the second front portion and the second rear portion;
a second workpiece engagement member including first and second pivots, the first and second pivots pivotably connected the first and second front portions, respectively, such that the second workpiece engagement member is adjacent the first workpiece engagement member;
a cutting edge formed on any one of the workpiece engagement members;
a slide element coupled to the medial portion of the second lever and retained in a sliding relationship with the medial portion;
an adjustment device connected to the first lever and configured to hold the slide element at selected positions along the medial portion; and
a linkage having third and fourth pivots, the third and fourth pivots pivotably connected to the second front portion and the coupling device, respectively, such that the second workpiece engagement member moves away from the first workpiece engagement member during movement of the second rear portion away from the first rear portion, thereby defining a cutting ratio between movement of the workpiece engagement members away from each other and movement of the rear portions away from each other;
wherein the selected positions of the slide element include a first position and a second position, the first position associated with a first cutting ratio, the second position associated with a second cutting ratio greater than the first cutting ratio.

11. The tool of claim 10 wherein the first position of the slide element defines a first distance between the fourth pivot and the first pivot, and the second position of the slide element defines a second distance between the fourth pivot and the first pivot, the second distance being less than the first distance.

12. The tool of claim 10 wherein the first lever includes a first channel having a bottom wall and two opposing side walls extending from the bottom wall, the bottom and side walls defining an interior portion within which the slide element may be moved along the medial portion.

13. The tool of claim 12 wherein the medial portion includes a rib formed on any one of the two side walls of the first channel, the rib protruding into the interior portion of the first channel and extending substantially parallel to the bottom wall of the first channel, the slide element being retained between the rib and the bottom wall.

14. The tool of claim 10 wherein:
the first lever further includes a cylindrical, rotatable handle disposed at the first rear portion, the rotatable handle sized and shaped to accommodate an entire hand of a user; and
the adjustment device includes a stationary threaded member attached to the first rear portion and an elongate, moveable threaded member attached to the rotatable handle, the threaded members coupled together such that the slide element changes position during rotation of the rotatable handle.

15. The tool of claim 14 wherein:
the moveable threaded member includes an annular notch; and
the slide element includes a U-shaped member having a base, two opposing arms extending from the base, a fourth pivot pin connected to at least one of the two arms, and an open-ended slot formed at the base, the fourth pivot pin configured to engage the fourth pivot of the linkage, the open-ended slot configured to engage the annular notch of the moveable threaded member.

16. The tool of claim 10 wherein the second lever further includes a second channel having a bottom portion, two opposing side portions extending from the bottom portion, a second pivot pin connecting the two side portions, and a third pivot pin connecting the two side portions and spaced apart from the second pivot pin, the second pivot pin configured to engage the second pivot of the second workpiece engagement member, the third pivot pin configured to engage the third pivot of the linkage.

17. The tool of claim 16 wherein the linkage includes a tab portion, the tab portion having a stop surface disposed at a distance from a line defined by the third and fourth pivots of the linkage, the distance selected such that the stop surface abuts the bottom portion of the second channel to prevent the second rear portion from contacting the first rear portion.

18. The tool of claim 10 wherein an elongate slot is formed on the first lever;
the tool further comprising a limit device that limits movement of the slide element along the medial portion of the first lever, the limit device including a protrusion extending into the elongate slot and attached to the second workpiece engagement member at a point spaced apart from the first and second pivots of the second workpiece engagement member; and
wherein the elongate slot has a minor dimension sized to accommodate the protrusion and a major dimension sized to allow the second workpiece engagement member to rotate about the first pivot during movement of the slide element, the elongate slot located on the first lever relative to the first pivot such that movement of the slide element is stopped at selected point on the medial portion.

19. A method of cutting a workpiece with a tool having a first lever, a first handle disposed on the first lever, a second lever, a second handle disposed on the second lever, a first blade disposed on the first lever, a second blade having first and second pivots pivotably attached to the first and second levers, respectively, a linkage having third and fourth pivots pivotably attached to the first and second levers, respectively, and an adjustment device connected to the first handle and the fourth pivot, the adjustment device configured to hold the fourth pivot at selected distances from the first pivot, the distances selected by rotation of the first handle, the method comprising:
creating an opening between the first and second blades, including separating the first and second handles from each other;
inserting a workpiece into the opening between the first and second blades;
pushing the blades into the workpiece, including grasping the first and second handles and moving the first and handles toward each other;
separating the first and second handles while keeping the first and second blades on the workpiece, including rotating the first handle while grasping the first and second handles; and
pushing the blades further into the workpiece after rotating the first handle, including moving the first and second handles toward each other a second time.
